(19) United States
(12) Patent Application Publication
(10) Pub. No.: US 2001/0049420 A1
(43) Pub. Date: Dec. 6, 2001

(54) Method for producing hydrocarbon/acrylic hybrid resins

(75) Inventor: Michael D. Matzinger, Charlotte, NC (US)

Correspondence Address: Daniel B. Reece IV, Westvaco Corporation, 5255 Virginia Avenue, Post Office Box 118005, Charleston, SC, 29423-8005, US

(73) Assignee: Westvaco Corporation, New York, NY (US)

(21) Appl. No.: 09/736,480

(22) Filed: Dec. 13, 2000

Related U.S. Application Data
(63) Continuation-in-part of application No. 09/315,622, filed on May 20, 1999, now abandoned.

(51) Int. Cl. C08F 265/00; C08L 33/08; C08L 33/10; C08F 265/04; C08F 265/02; C08L 33/12

(52) U.S. Cl. 525/329.7; 525/94; 525/330.2; 525/330.3; 525/330.6

(57) ABSTRACT

The present invention relates to novel hydrocarbon resins and the process for preparing them. In particular, the invention relates to the production of hydrocarbon/acrylic hybrid resins which are suitable for use in formulating adhesives, printing inks, and other coating compositions.

This application is a continuation-in-part of our commonly assigned, co-pending U.S. patent application Ser. No. 09/315,622 filed May 20, 1999, entitled “Method for Producing Hydrocarbon/Acrylic Hybrid Resins”.

### FIELD OF INVENTION

The present invention relates to novel hydrocarbon resins and the process for preparing them. In particular, the invention relates to the production of hydrocarbon/acrylic hybrid resins which are suitable for use in formulating adhesives, printing inks, and other coating compositions.

### BACKGROUND OF THE INVENTION

Hydrocarbon resins are common materials used in formulating adhesives, printing inks, and coating compositions. The basic hydrocarbon resins are produced from either thermal polymerization of reactive olefins composed chiefly of dicyclopentadiene, or Lewis acid catalyzed polymerization of various vinyl aromatic monomers.

Dicyclopentadiene (DCPD) is a material which will readily form resins when heated to temperatures greater than 200° C. Polymerization apparently occurs through cyclopentadiene which is formed when dicyclopentadiene is heated above 170° C. Chain growth of the polymer proceeds via a free radical mechanism with both 1:4 and 1:2 addition occurring as is shown in Equation I below.

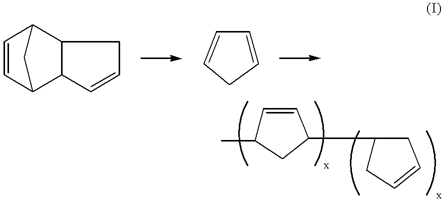

If dicyclopentadiene is heated to and maintained at 200° C., the predominant reaction occurring is oligomerization by the Diels-Alder addition of cyclopentadiene to the norbornyl double bond of the dimer, trimer, etc., as set forth in Equation II below.

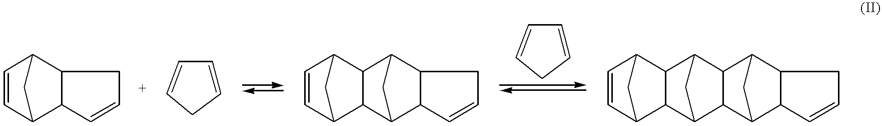

Usually, the largest oligomer formed is the pentamer. The Diels-Alder oligomers are often referred to as thermal polymers of dicyclopentadiene, but their low molecular weight and insolubility in organic solvents make them virtually useless for commercial ink applications and of limited use in adhesive and coating applications.

The reaction of rosin and tall oil with dicyclopentadiene under pressure at temperatures greater than 400° F. (204° C.) is known to produce a resinous material. The resins produced, claimed useful as synthetic surface coatings, particularly in the paint and varnish field, are light colored resins with low softening points and reduced acid numbers. The softening points of such resins made with rosin are in the range of 215° to 250° F. (102° to 121° C.). The resin products made from refined tall oil are liquids unless a substantial excess of dicyclopentadiene is employed.

Cyclopentadiene can be used for the reaction with rosin and tall oil. However, as cyclopentadiene quickly equilibrates with dicyclopentadiene under the above conditions, the use of dicyclopentadiene produces similar products.

The drop in acid number of the products indicates the consumption of the acid function of the rosin or tall oil. This results from the addition of carboxyl functions across double bonds to produce esters. It is assumed that this addition occurs across the norbornyl-type double bonds of DCPD, DCPD oligomers, and DCPD polymers, as set forth in Equation III, below.

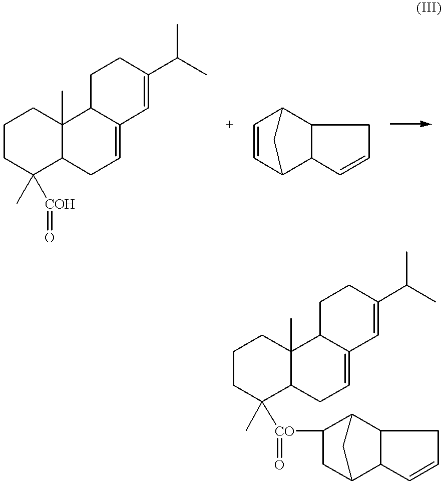

Likewise, the thermal polymerization of dicyclopentadiene with tall oil fatty acids is attributed, in U.S. Pat. No. 4,292,221, to the addition of the acid functions to the bicycloheptene double bonds of the hydrocarbon resin. The patentees teach fatty acid heated with dicyclopentadiene to produce resins suitable for offset printing.

U.S. Pat. No. 4,242,244 discloses that carboxylic acids will add to preformed, thermal cyclopentadiene resins if the resins contain the reactive bicycloheptene double bonds, as set forth in Equation IV below.

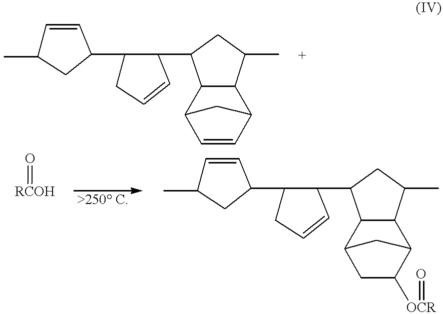

The reaction between dicyclopentadiene, a mixture of dimerized conjugated aliphatic cyclic and non-cyclic dienes of five carbon atoms, and distilled tall oil is described in U.S. Pat. No. 4,056,498 to produce an intermediate which is adducted with maleic anhydride to produce a final ink resin.

U.S. Pat. Nos. 4,362,848, 4,387,182, and 4,389,512 disclose vinyl aromatic and cycloaliphatic acrylate containing dicyclopentadiene-based polymers. These polymers were prepared using boron trifluoride as the catalyst. Monomers such as acrylic acid, methacrylic acid, and styrene were reacted with dicyclopentadiene monomers such that a polymer with the vinyl aromatic and acrylate monomers within the polymer chain were obtained.

U.S. Pat. No. 4,976,783 discloses the preparation of modified cyclopentadiene resins by copolymerizing dicyclopentadiene with monomers such as styrene, methyl methacrylate, and vinyl acetate. These monomers are polymerized within the resulting cyclopentadiene-based polymer and are not attached through addition of the acid functionality of the monomers to the norbornyl site of the cyclopentadiene.

Printing ink resins are disclosed in U.S. Pat. No. 4,189,410 to be prepared by reacting dicyclopentadiene, rosin acids and a hydrocarbon containing material selected from debutanized aromatic concentrates, C₅-olefins, and acyclic, conjugated C₅-dienes; and, in U.S. Pat. No. 4,433,100, printing ink resins are prepared by reacting dicyclopentadiene, rosin acids and a hydrocarbon selected from mono-olefins, diolefins, and polyenes having more than 5 carbon atoms and no aromatic rings. In U.S. Pat. No. 4,574,057, printing ink resins are prepared by reacting dicyclopentadiene, tall oil or rosin acids, an unsaturated lower aliphatic acid or anhydride, a material with two reactive groups including a hydroxyl group and a hydrocarbon. The hydrocarbon can be that disclosed in U.S. Pat. Nos. 4,189,410 or 4,433,100, or can be a dimerized aliphatic, cyclic, or non-cyclic diene of five carbon atoms.

Also, rosin-cyclopentadiene resins are disclosed for gravure printing in U.S. Pat. No. 4,092,283. A cyclopentadiene resin is heated with rosin and maleic anhydride to 250-270° C. to form ester bonds, obtaining resins having an acid number of 60 and a softening point of 165° C. After several hours, metal oxides are added to form resinates.

When rosin and dicyclopentadiene are thermally reacted, low acid number hybrid resins are obtained. Their major shortcoming is low Gardner viscosities relative to standard rosin-based or reactive hydrocarbon lithographic ink resins. In commonly assigned U.S. Pat. Nos. 5,391,615 and 5,403,391 (which are hereby incorporated by reference) preparation of resins with higher viscosities by thermally reacting phenolic-modified rosin and dicyclopentadiene and their use as lithographic ink resins are disclosed. However, problems exist with the manufacture and utilization of these resins. For example, relatively long chemical reaction cycle times are required to produce these resins. Also the product properties of these resins are somewhat restricted.

Therefore, an object of this invention is to solve this major problem by disclosing a method of producing novel modified hydrocarbon resins.

A further object of this invention is to provide a method for the production of novel hydrocarbon/acrylic hybrid resins having properties that render them suitable for use in formulating adhesives.

Yet another an object of this invention is to provide novel modified hydrocarbon/acrylic resins suitable for use in adhesives, printing inks, or other coating applications.

Other objects, features, and advantages of the invention will be apparent from the details of the invention as more fully described and claimed.

### SUMMARY OF THE INVENTION

The objects of this invention are achieved by reacting carboxylic acid functionalized acrylic polymers with dicyclopentadiene and other hydrocarbon monomers to produce the desired hydrocarbon/acrylic hybrid resin compositions. Alternatively, the objects of this invention are also achieved by reacting carboxylic acid functionalized acrylic polymers with dicyclopentadiene and hydrocarbon resins and/or modified hydrocarbon resins to produce the desired hydrocarbon/acrylic hybrid resin compositions. These compositions may be used to formulate adhesives, printing inks, and other coating compositions with enhanced characteristics.

The invention also encompasses the novel resin compositions of this method, as well as the use of the resin compositions in adhesive formulations.

The present invention improves upon the methods taught in U.S. Pat. Nos. 5,391,615 and 5,403,391 by teaching the incorporation of acrylic polymers. This utilization permits the practitioner to employ a wider range of synthetic processes, thereby allowing the production of resins with augmented chemical properties. Furthermore, as the present invention permits more flexible production on an industrial scale, the practitioner can decrease production costs by reducing the chemical reaction cycle times.

### DESCRIPTION OF THE PREFERRED EMBODIMENT

The method for producing a hydrocarbon/acrylic hybrid resin composition comprises reacting:

a) about 2% to about 63% by total weight of the reactants of dicyclopentadiene;

b) about 2% to about 63% by total weight of the reactants of a member selected from the group consisting of hydrocarbon monomers capable of undergoing polymerization with dicyclopentadiene, and combinations thereof;

c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b); and

d) up to about 63% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

at a temperature of from about 160° C. to about 300° C. for a time sufficient to produce the hydrocarbon/acrylic hybrid resin composition.

A preferred method for producing an hydrocarbon/acrylic hybrid resin composition comprises reacting:

a) about 10% to about 40% by total weight of the reactants of dicyclopentadiene;

b) about 10% to about 40% by total weight of the reactants of a member selected from the group consisting of hydrocarbon monomers capable of undergoing polymerization with dicyclopentadiene and combinations thereof;

c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b); and

d) up to about 40% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

at a temperature of from about 220° C. to about 280° C. for a time sufficient to produce the hydrocarbon/acrylic hybrid resin composition.

Where desired, hydrocarbon/acrylic hybrid resin compositions may be produced via a two-step process. This method for producing an hydrocarbon/acrylic hybrid resin composition comprises:

1) reacting

a) about 2% to about 63% by total weight of the reactants of dicyclopentadiene;

b) about 2% to about 63% by total weight of the reactants of a member selected from the group consisting of hydrocarbon monomers capable of undergoing polymerization with dicyclopentadiene and combinations thereof; and

c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b);

at a temperature of from about 160° C. to about 300° C. for a time sufficient to produce a resin composition; and

2) further reacting:

a) about 35% to about 98% by total weight of the reactants of said resin composition, and

b) about 2% to about 65% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

at a temperature of from about 160° C. to about 300° C. for a time sufficient to produce the hydrocarbon/acrylic hybrid resin composition.

A preferred two-step process for producing hydrocarbon/acrylic hybrid resin compositions comprises:

1) reacting

a) about 10% to about 40% by total weight of the reactants of dicyclopentadiene;

b) about 10% to about 40% by total weight of the reactants of a member selected from the group consisting of hydrocarbon monomers capable of undergoing polymerization with dicyclopentadiene and combinations thereof; and

c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b);

at a temperature of from about 220° C. to about 280° C. for a time sufficient to produce a resin composition, and

2) further reacting

a) about 50% to about 80% by total weight of the reactants of said resin composition, and

b) about 20% to about 50% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

at a temperature of from about 220° C. to about 280° C. for a time sufficient to produce the hydrocarbon/acrylic hybrid resin composition.

A further method for producing a hydrocarbon/acrylic hybrid resin composition comprises reacting:

a) about 2% to about 63% by total weight of the reactants of dicyclopentadiene;

b) about 2% to about 63% by total weight of the reactants of a member selected from the group consisting of hydrocarbon resins, modified hydrocarbon resins, and combinations thereof;

c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b); and

d) up to about 63% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

at a temperature of from about 140° C. to about 300° C. for a time sufficient to produce the hydrocarbon/acrylic hybrid resin composition.

A preferred method for producing an hydrocarbon/acrylic hybrid resin composition comprises reacting:

a) about 10% to about 40% by total weight of the reactants of dicyclopentadiene;

b) about 10% to about 40% by total weight of the reactants of a member selected from the group consisting of hydrocarbon resins, modified hydrocarbon resins, and combinations thereof;

c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b); and

d) up to about 40% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

at a temperature of from about 180° C. to about 260° C. for a time sufficient to produce the hydrocarbon/acrylic hybrid resin composition.

Where desired, hydrocarbon/acrylic hybrid resin compositions may be produced via a two-step process. This method for producing an hydrocarbon/acrylic hybrid resin composition comprises

1) reacting

a) about 2% to about 63% by total weight of the reactants of dicyclopentadiene;

b) about 2% to about 63% by total weight of the reactants of a member selected from the group consisting of hydrocarbon resins, modified hydrocarbon resins, and combinations thereof; and

c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b);

at a temperature of from about 140° C. to about 300° C. for a time sufficient to produce a resin composition; and

2) further reacting:

a) about 35% to about 98% by total weight of the reactants of said resin composition, and

b) about 2% to about 65% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

at a temperature of from about 140° C. to about 300° C. for a time sufficient to produce the hydrocarbon/acrylic hybrid resin composition.

A preferred two-step process for producing hydrocarbon/acrylic hybrid resin compositions comprises:

1) reacting

a) about 10% to about 40% by total weight of the reactants of dicyclopentadiene;

b) about 10% to about 40% by total weight of the reactants of a member selected from the group consisting of hydrocarbon resins, modified hydrocarbon resins, and combinations thereof; and

c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b);

at a temperature of from about 180° C. to about 260° C. for a time sufficient to produce a resin composition, and

2) further reacting

a) about 50% to about 80% by total weight of the reactants of said resin composition, and

b) about 20% to about 50% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;

at a temperature of from about 180° C. to about 260° C. for a time sufficient to produce the hydrocarbon/acrylic hybrid resin composition.

Depending upon the characteristics desired, the hydrocarbon/acrylic hybrid resin compositions of the present invention can be formed via two differing methods. In one method, hydrocarbon/acrylic resins are formed by heating a mixture of hydrocarbon monomers (wherein one of the monomers is dicyclopentadiene), one or more acrylic resins and, optionally, specified additional chemical compounds to temperatures of from about 160° C. to about 300° C. (preferably from about 220° C. to about 280° C.). The weight ratio of acrylic polymer to hydrocarbon monomers usually is about 2:1 to 1:45. The components are charged to a reactor which is then sealed and heated to a temperature within the desired range. The procedure generally is performed under an inert atmosphere by purging the charged reactor with nitrogen prior to sealing it. As the mixture is heated, an autogenous pressure of between 70 and 160 psig is usually generated. After maximizing, this pressure generally falls to between 40 and 70 psig as the polymerization proceeds. The reaction mixture is maintained at a temperature within the desired range under pressure for a period sufficient to achieve a hydrocarbon/acrylic hybrid resin possessing the desired properties. Typically a time of at least three hours is employed. Following this, the reactor is vented to reduce the pressure to 0 psig. Next, unreacted hydrocarbon monomers and inert compounds that would depress the softening point of the resin and give it an offensive odor are distilled from the reaction mixture. The removal of these materials is promoted by sparging the resin with nitrogen. Nitrogen is bubbled through the reaction mixture generally at a rate of 0.001 to 0.01 lb of N₂ per lb of reactants per hour. The length of this step is dependent on the desired properties of the resin but typically is conducted from one to ten hours.

Alternatively, in the second method hydrocarbon/acrylic hybrid resins of the present invention are formed by heating a mixture of dicyclopentadiene, one or more hydrocarbon-based resins, one or more acrylic resins and, optionally, specified additional chemical compounds to temperatures of from about 140° C. to about 300° C. (preferably from about 180° C. to about 260° C.). The weight ratio of acrylic polymer to dicyclopentadiene and hydrocarbon resins usually is about 10:1 to 1:30. The components are charged to a reactor which is then heated to a temperature within the desired range. The procedure generally is performed at atmospheric pressure; however, the reaction can be performed at an autogenous pressure. The reaction mixture is maintained at a temperature within the desired range for a period sufficient to bind the dicyclopentadiene and acrylic polymers together and to achieve a hydrocarbon/acrylic hybrid resin having the desired properties. Typically a period of time of at least two hours is employed.

Unexpectedly, the method by which the hydrocarbon/acrylic hybrid resin is prepared impacts the properties of the resin. That is, resins with different chemical characteristics are obtained according to whether hydrocarbon monomers or hydrocarbon resins are employed. Compared to the resins made via the first method (using hydrocarbon monomers), the resins produced via the second method (using hydrocarbon resins) are lower in softening point and molecular weight. These former resins may be more appropriate for lithographic and gravure printing ink applications while the resin made according to the second method may be more appropriate for coating, adhesive, and electrophotographic toner applications.

Suitable hydrocarbon monomers must be capable of undergoing polymerization with dicyclopentadiene. The hydrocarbon monomer typically employed to make the hydrocarbon/acrylic resin is a technical grade dicyclopentadiene which contains from about 75 to 85% dicyclopentadiene and a variety of other hydrocarbon monomers. Examples of such materials that are commercially available are DCPD 101 (a product of Lyondell Petrochemical) and DCP-80P (a product of Exxon). Other components in the dicyclopentadiene are inert hydrocarbons (such as toluene, xylenes and saturated hydrocarbons with from 4 to 6 carbons), and various codimers and cotrimers formed by the Diels-Alder condensation of butadiene, cyclopentadiene, methylcyclopentadiene, and acyclic pentadienes.

The above-noted hydrocarbon monomers may be employed in thermal polymerization reactions to produce hydrocarbon resins and modified hydrocarbon resins suitable for use in the present method.

Likewise, aromatic hydrocarbons having a vinyl group conjugated to the aromatic ring may be employed to produce hydrocarbon resins and modified hydrocarbon resins suitable for use in the present method. The vinyl aromatic compounds are incorporated into the growing dicyclopentadiene containing polymer by free radical addition to the vinyl group. Examples of such aromatic monomers are styrene, vinyl toluene, α-methyl styrene, β-methyl styrene, indene and methyl indene. Typically, hydrocarbon mixtures that contain from 50 to 100% of such compounds are used. Other components found in these mixtures are usually inert aromatic compounds, e.g., toluene, xylenes, alkylbenzenes and naphthalene. A commercially available example of such a mixture is LRO-90® (a product of Lyondell Petrochemical). A typical analysis of this materials is: xylene (1-5%), styrene (1-10%), α-methylstyrene (1-3%), β-methylstyrene (1-5%), methylindene (5-15%), trimethylbenzenes (1-20%), vinyltoluene (1-30%), indene (1-15%) and naphthalene (1-5%).

When incorporating vinyl aromatic monomers to produce hydrocarbon resins or modified hydrocarbon resins, the procedure for preparing the resin is the same. The vinyl aromatic component is added along with the dicyclopentadiene and other hydrocarbon monomer. The aromatic component is added to the reaction mixture in an amount less than the dicyclopentadiene used. Generally, the aromatic component is employed in an amount no greater than 30% by weight of the total reaction mixture. Preferably, the vinyl aromatic component is used from about 5 to 20% of the total reagent charge.

For both synthetic methods, the amount of dicyclopentadiene monomer used in the preparation of the hydrocarbon/acrylic resin must be sufficient so as to provide at least one or more sites for the acrylic polymer to attach. Likewise, the acrylic polymer used in each method must have a sufficient number of acid sites so that at least one reaction with a dicyclopentadiene polymer can occur.

Although the mechanism of the reaction is not completely understood, it appears that an important aspect of the acrylic polymer is that the polymer possess: a) one or more carboxylic acid and/or carboxylic acid-precursor groups (i.e., be carboxylic acid functionalized), or b) that the polymer be both carboxylic acid functionalized and hydroxyl functionalized (i.e., also possess one or more hydroxyl and/or hydroxyl-precursor groups). These chemical characteristics permit the acrylic polymer to react in a cycloaddition reaction with the norbornyl-type double bonds in the dicyclopentadiene resin. In this way the acrylic polymer is chemically bound (grafted) to the hydrocarbon polymer, thereby yielding a hydrocarbon/acrylic graft copolymer.

The mechanism of grafting employed in the present invention is the cycloaddition of a carboxyl group on a preformed acrylic polymer across a double bond (e.g., norbornenyl double bonds) of the hydrocarbon resin. The attachment of the acrylic resin occurs through an ester linkage in the cycloaddition graft, thereby allowing the acrylic chains to be attached to the hydrocarbon somewhere at mid-chain of the acrylic resin. The employment of this cycloaddition mechanism affords the user a great deal of flexibility in designing desired graft polymer structures.

Polymers that contain more than one acid group or hydroxyl group may be used and therefore are capable of reacting with more than one norbornyl-type double bond and acting as cross-linking agents between hydrocarbon polymer molecules. Furthermore, because the number of acid groups or hydroxyl groups on the acrylic polymer can be varied by changing the monomer composition, the crosslinking ability of the polymer can exceed that of modified rosin resins such as fumaric acid-adducted phenolic rosin resins, modified fatty acids such as maleic anhydride-adducted linoleic acid, polyols such as pentaerythritol and sorbitol, polyamines such as 2-methylpentamethylene and hexamethylenediamine, polyaziridines such as IONAC® PFAZ-322 (supplied by Sybron Chemicals Inc.), and alkanolamines such as diethanolamine. The use of acrylic polymers with multiple acid groups or hydroxyl groups allows the preparation of hydrocarbon/acrylic resins with properties that cannot be obtained by using resins with one or several acid groups or hydroxyl groups. For example, the use of multiple acid group-containing polymers or multiple hydroxyl group-containing polymers allows the synthesis of hydrocarbon/acrylic resins of molecular weight, viscosity, softening point, and efflux cup dilution properties higher than achievable using materials such as rosin and fatty acid and their derivatives.

Alcohols and alkyl amines which are suitable for use in the present method are those compounds which are capable of undergoing an insertion reaction across a norbornyl site and/or an esterification reaction with an acid group or an acid equivalent functional group, and the like. Where desired, the molecular weight of the hydrocarbon/acrylic resin can be increased by treating the hydrocarbon/acrylic resin with a compound containing one or more functionalities from the group consisting of polyols, polyamines, polyaziridines, alkanolamines, polysulfides, and alkanolsulfides. Examples of polyols suitable for use in the present methods include pentaerythritol, glycerin, ethylene glycol, sorbitol, and the like. Examples of suitable polyamines include 2-methylpentamethylenediamine, bis(hexamethylene) triamine, 1,3-pentanediamine, and the like. Examples of suitable polyaziridines include IONAC® PFAZ-322 (supplied by Sybron Chemicals Inc.) and similar compounds. Examples of suitable polysulfides include glycerol dimercaptoacetate, pentaerythritol tetra(3-mercaptopropionate), trimethylolpropane trithioglycolate, polyethylene glycol dimercaptoacetate, and the like. Examples of suitable alkanolsulfides include glycerol monothioglycolate, monoethanolamine thioglycolate, 1-thioglycerol, and the like.

Specific examples of preferred carboxylic acid-functionalized acrylic polymers usable herein include a copolymer of styrene or a styrene derivative with acrylic acid or methacrylic acid. Styrene monomers usable herein include styrene, and further, styrene derivatives such as methylstyrene, dimethylstyrene, trimethylstyrene, α-chlorostyrene, α-methylstyrene, and the like. The copolymers may contain other monomers. Examples of other monomers include unsaturated monomers including vinyl halides, vinyl esters, mono vinylidene aromatics, α,β-unsaturated carboxylic acids and esters thereof, unsaturated dicarboxylic anhydrides, and mixtures thereof, and other monomers copolymerizable with styrene and (meth)acrylic acid. Polymerization methods are not particularly limited, and polymers having various monomer ratios are commercially available and may be used in the present invention.

Commercially available carboxylic acid-functionalized acrylic polymers include JONREZ® H-2700, H-2701, H-2702, and H-2704 (supplied by the Westvaco Corp.), JONCRYL® 678, 682, and 690 (supplied by S. C. Johnson, Inc.), MOREZ® 101 and 300 (supplied by Morton Int., Inc.), and VANCRYL® 65 and 68 (supplied by Air Products and Chemicals, Inc.). Commercially available hydroxyl-functionalized acrylic polymers include JONREZ® H-2703 (supplied by the Westvaco Corp.) and JONCRYL® 587 (supplied by S. C. Johnson, Inc.).

In a further embodiment of the invention, the hydrocarbon/acrylic resin may be reacted with α,β-unsaturated carboxylic acids, α,β-unsaturated carboxylic diacids, α,β-unsaturated carboxylic anhydrides, and the like. Examples of such carboxylic compounds which are suitable for use in the present method include those which are capable of undergoing an insertion reaction across a norbornyl site and/or an esterification reaction with an acid group or an acid equivalent functional group. Other carboxylic compounds which are suitable for use in the present method include those which are capable Diels-Alder addition or ene reaction. Specific examples of such compounds include maleic anhydride, fumaric acid, itaconic acid, itaconic anhydride, crotonic acid, acrylic acid, methacrylic acid, and the like. These compounds react with the resin by a Diels-Alder addition or ene reaction, thus incorporating without loss of their carboxylic acid or anhydride functions. The reaction can be performed in the temperature range of 180-240° C., with the a range of 190-210° C. preferred. In general, from about 2 wt. % to about 15 wt. % of the α,β-unsaturated carboxylic acids, diacids or anhydrides can be added to the reaction mixture, but it is preferred that from about 4 wt. % to about 8 wt. % be used.

In a further embodiment of the invention, an α,β-unsaturated carboxylic acid, α,β-unsaturated carboxylic diacid, or α,β-unsaturated carboxylic anhydride can be incorporated into the hydrocarbon/acrylic resin during the polymerization reaction, thus incorporating without loss of their carboxylic acid or anhydride functions. Examples of such compounds are given in the previous paragraph. In general, from about 2 wt. % to about 40 wt. % of the α,β-unsaturated carboxylic acids, α,β-unsaturated carboxylic diacids, or α,β-unsaturated carboxylic anhydrides can be added to the reaction mixture, but it is preferred that from about 4 wt. % to about 15 wt. % be used.

In a further embodiment of the invention, the hydrocarbon/acrylic resin may be reacted with fatty acids, fatty acid compounds, rosin acids, and/or rosin resins. Examples of such compounds which are suitable for use in the present method include those which are capable of undergoing an insertion reaction across a norbornyl site and/or an esterification reaction with an acid group or an acid equivalent functional group.

Fatty acids which are suitable for use in the present invention include, but are not limited to, the following: unsaturated fatty acids, saturated fatty acids, dimerized fatty acids, modified fatty acids, and combinations thereof. Suitable fatty acid compounds include the Diels-Alder cyclo-adducts and the ene-addition reaction products of unsaturated and polyunsaturated fatty acids with acrylic acid, acrylic acid derivatives, fumaric acid, and/or maleic anhydride.

In a further embodiment of the invention, rosin and rosin-based resins can be incorporated into the hydrocarbon/acrylic resin either during or after the polymerization reaction. Rosins suitable for this invention include tall oil rosin, gum rosin and wood rosin. Synthetic sources of these rosin acids may also be used. The modification of rosin with components such as phenols, α,β-unsaturated carboxylic acid, and polyols to produce rosin-based resins is a well established method for producing rosin-based resins. Examples of such suitable rosin-based resins are the JONREZ® RP-300, SM-700, IM-800, and HC-900 resin series (supplied by the Westvaco Corp.).

In a further embodiment of the invention, mononuclear phenols, polynuclear phenols, or phenol-based resins (i.e., novolacs or resoles) can be incorporated into the hydrocarbon/acrylic resin either during or after the polymerization reaction. Examples of such phenolic compounds which are suitable for use in the present method include those which are capable of undergoing an insertion reaction across a norbornyl site and/or an esterification reaction with an acid group or an acid equivalent functional group. These phenolic compounds can also be reacted with suitable aldehydes and/or aldehyde acetals either prior to or following the insertion reaction or esterification reaction. Among the phenolic compounds that can be used to modify the resin are phenol, bisphenol-A, para-tert-butylphenol, para-octylphenol, para-nonylphenol, para-dodecylphenol, para-phenylphenol, novolac resins such as HRJ-1166, HRJ-1367, SP-134, SP-560, SP-1068, SP-1077, and SRF-1524 (all supplied by Schenectady International, Inc.), resole resins, and mixtures thereof. Aldehydes which are suitable for use in the present invention include, but are not limited to, the following: paraformaldehyde, formaldehyde, and combinations thereof.

The following examples are provided to further illustrate the present invention and are not to be construed as limiting the invention in any manner. All parts are by weight unless otherwise stated.

### EXAMPLE 1

Into a one-liter autoclave reactor were charged 250 parts of DCPD 101® (a dicyclopentadiene supplied by Lyondell Petrochemical) and 100 parts JONREZ® H-2702 (a polymer having an acid number of 206 supplied by the Westvaco Corp.). The charged autoclave was purged with nitrogen and sealed. The reaction mixture was heated to 265° C. over a one hour period and was maintained at 265° C. for five hours. The reactor was then vented carefully, and the molten resin composition was poured into an aluminum pan and was allowed to cool.

Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 260° C. At 260° C., the nitrogen inlet tube was immersed in the liquid resin and the nitrogen flow was adjusted to a rate of approximately 400 ml/min. The resin was sparged for two hours and then discharged into an aluminum pan.

The resulting hydrocarbon/acrylic hybrid resin composition had an acid number of 9 and a Ring and Ball softening point of 178° C. The resin was insoluble in alkaline refined linseed oil and in MAGIESOL® 47 oil (a hydrocarbon solvent supplied by Magie Brothers Oil Co.).

Fourier Transform-Infrared and Gel Permeation Chromotography analysis of the resin was used to confirm a reaction of the acrylic polymer with dicyclopentadiene or a dicyclopentadiene polymer. The presence of the peaks at 1727 cm⁻¹ and 1160 cm⁻¹ in the FT-IR spectrum are consistent with ester formation. GPC analysis provided the following data consistent with polymer formation: 47.4K weight-average-molecular-weight, 266K M_{Z}, and 391K M_{Z+1}.

A solvent-based pressure sensitive adhesive can be prepared by mixing 50 parts of the hydrocarbon/acrylic hybrid resin composition, 100 parts of hot-polymerized styrene-butadiene rubber, 25 parts of pentaerythritol ester of hydrogenated rosin (104° C. softening point), 2 parts of an antioxidant, and 1,167 parts of toluene.

### EXAMPLE 2

Into a one-liter autoclave reactor were charged 400 parts of DCPD 101® (a dicyclopentadiene supplied by Lyondell Petrochemical) and 160 parts JONREZ® H-2701 (a styrene/acrylic polymer having an acid number of 206 supplied by the Westvaco Corp.). The charged autoclave was purged with nitrogen and sealed. The reaction mixture was heated to 260° C. over a two hour period and was maintained at 260° C. for six hours. The reactor was then vented carefully, and the molten resin was poured into an aluminum pan and was allowed to cool. The resin had an acid number of 35.

Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 260° C. At 260° C., the nitrogen inlet tube was immersed in the liquid resin and the nitrogen flow was adjusted to a rate of approximately 400 ml/min. The resin was sparged for two hours and then discharged into an aluminum pan.

The resulting hydrocarbon/acrylic resin composition had an acid number of 3 8 and a Ring and Ball softening point of 140° C. GPC analysis provided the following data consistent with polymer formation: 10.5K weight-average-molecular-weight, 45.2K M_{Z}, and 77.8K M_{Z+1}. The resin was insoluble in alkaline refined linseed oil and in MAGIESOL® 47 oil (a hydrocarbon solvent supplied by Magie Brothers Oil Co.).

A hot-melt pressure sensitive adhesive can be prepared by mixing 40 parts of the hydrocarbon/acrylic composition, 40 parts of a styrene-butadiene multiblock copolymer, 20 parts of a pentaerythritol ester of tall oil rosin, 20 parts of naphthenic oil, and 2 parts of an antioxidant.

### EXAMPLE 3

Into a one-liter autoclave reactor were charged 350 parts of DCPD 101® (a dicyclopentadiene supplied by Lyondell Petrochemical) and 100 parts a polymer comprised of 30 wt. % of styrene, 20 wt. % of acrylic acid, and 50 wt. % of maleic half-ester of one-mole ethoxylate of ROSIN SS® (a tall oil rosin supplied by the Westvaco Corp.) and having an acid number of 160). The charged autoclave was purged with nitrogen and sealed. The reaction mixture was heated to 260° C. over a one hour period and was maintained at 260° C. for five hours. The reactor was then vented carefully, and the molten resin was poured into an aluminum pan and was allowed to cool. The resin had an acid number of 17.

Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 260° C. At 260° C., the nitrogen inlet tube was immersed in the liquid resin and the nitrogen flow was adjusted to a rate of approximately 400 ml/min. The resin was sparged for 90 minutes and then discharged into an aluminum pan.

The resulting hydrocarbon/acrylic resin composition had an acid number of 20 and a Ring and Ball softening point of 139° C. GPC analysis provided the following data consistent with polymer formation: 5.8K weight-average-molecular-weight, 34.5K M_{Z}, and 62.4K M_{Z+1}. The resin was insoluble in alkaline refined linseed oil and in MAGIESOL® 47 oil (a hydrocarbon solvent supplied by Magie Brothers Oil Co.).

### EXAMPLE 4

Into a one-liter autoclave reactor were charged 375 parts of DCPD 101® (a dicyclopentadiene supplied by Lyondell Petrochemical), 150 parts LRO-90® (a hydrocarbon mixture containing vinyl aromatic compounds supplied by Lyondell Petrochemical), and 100 parts JONREZ® H-2702 (a styrene/acrylic polymer having an acid number of 200 supplied by the Westvaco Corp.). The charged autoclave was purged with nitrogen and sealed. The reaction mixture was heated to 265° C. over a 90 minute period and was maintained at 260° C. for four hours. The reactor was then vented carefully, and the molten resin was poured into an aluminum pan and was allowed to cool.

Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 260° C. At 260° C., the nitrogen inlet tube was immersed in the liquid resin and the nitrogen flow was adjusted to a rate of approximately 400 ml/min. The resin was sparged for one hour and then discharged into an aluminum pan.

The resulting hydrocarbon/acrylic resin composition had an acid number of 5 and a Ring and Ball softening point of 140° C. The resin was insoluble in alkaline refined linseed oil and in MAGIESOL® 47 oil (a hydrocarbon solvent supplied by Magie Brothers Oil Co.).

### EXAMPLE 5

Into a one-liter autoclave reactor were charged 350 parts of DCPD 101® (a dicyclopentadiene supplied by Lyondell Petrochemical), 150 parts LRO-90® (a hydrocarbon mixture containing vinyl aromatic compounds supplied by Lyondell Petrochemical), 100 parts JONREZ® H-2702 (a styrene/acrylic polymer having an acid number of 200 supplied by the Westvaco Corp.), and 25 parts NEODENE® 16 (a 1-hexadecene supplied by Shell Chemical Co.). The charged autoclave was purged with nitrogen and sealed. The reaction mixture was heated to 265° C. over a 45 minute period and was maintained at 260° C. for five hours. The reactor was then vented carefully, and the molten resin was poured into an aluminum pan and was allowed to cool.

Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 260° C. At 260° C., the nitrogen inlet tube was immersed in the liquid resin and the nitrogen flow was adjusted to a rate of approximately 400 ml/min. The resin was sparged for 30 minutes and then discharged into an aluminum pan.

The resulting hydrocarbon/acrylic resin composition had an acid number of 7 and a Ring and Ball softening point of 130° C. The resin was insoluble in alkaline refined linseed oil and in MAGIESOL® 47 oil (a hydrocarbon solvent supplied by Magie Brothers Oil Co.).

### EXAMPLE 6

Into a one-liter autoclave reactor were charged 350 parts of DCPD 101® (a dicyclopentadiene supplied by Lyondell Petrochemical), 150 parts LRO-90® (a hydrocarbon mixture containing vinyl aromatic compounds supplied by Lyondell Petrochemical), 100 parts SAAEHA (a polymer comprised of 60 wt. % styrene, 20 wt. % acrylic acid, and 20 wt. % 2-ethyl hexyl acrylate and having an acid number of 128), and 25 parts NEODENE® 16 (a 1-hexadecene supplied by Shell Chemical Co.). The charged autoclave was purged with nitrogen and sealed. The reaction mixture was heated to 265° C. over a 45 minute period and was maintained at 260° C. for five hours. The reactor was then vented carefully, and the molten resin was poured into an aluminum pan and was allowed to cool.

Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 260° C. At 260° C., the nitrogen inlet tube was immersed in the liquid resin and the nitrogen flow was adjusted to a rate of approximately 400 ml/min. The resin was sparged for 30 minutes and then discharged into an aluminum pan.

The resulting hydrocarbon/acrylic resin composition had an acid number of 4, a Ring and Ball softening point of 111° C., a viscosity at 25° C. of 9 line-to-line seconds (33 wt. % resin in alkaline refined linseed oil) and 20 line-to-line seconds (50 wt. % resin in MAGIESOL® 47 oil [a hydrocarbon solvent supplied by Magie Brothers Oil Co.]), 45% tolerance (titration of the resin/MAGIESOL® 47 oil solution with additional MAGIESOL® 47 oil until a cloud point is reached), and Gardner color of 11+ (33 wt. % resin in alkaline refined linseed oil).

### EXAMPLE 7

Into a one-liter autoclave reactor were charged 350 parts of DCPD 101® (a dicyclopentadiene supplied by Lyondell Petrochemical), 150 parts LRO-90® (a hydrocarbon mixture containing vinyl aromatic compounds supplied by Lyondell Petrochemical), and 100 parts of SAAEHA (a solution polymer comprised of 60 wt. % styrene, acrylic acid, and 2-ethyl hexyl acrylate and having an acid number of 128). The charged autoclave was purged with nitrogen and sealed. The reaction mixture was heated to 265° C. over a 90 minute period and was maintained at 260° C. for four hours. The reactor was then vented carefully, and the molten resin was poured into an aluminum pan and was allowed to cool.

Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 260° C. At 260° C., the nitrogen inlet tube was immersed in the liquid resin and the nitrogen flow was adjusted to a rate of approximately 400 ml/min. The resin was sparged for 30 minutes and then discharged into an aluminum pan.

The resulting hydrocarbon/acrylic resin composition had an acid number of 5, a Ring and Ball softening point of 121° C., a viscosity at 25° C. of 14 line-to-line seconds (33 wt. % resin in alkaline refined linseed oil), and Gardner color of 11+ (33 wt. % resin in alkaline refined linseed oil). The resin was not soluble in MAGIESOL® 47 oil (a hydrocarbon solvent supplied by Magie Brothers Oil Co.).

### EXAMPLE 8

Into a one-liter autoclave reactor were charged 377 parts of DCPD 101® (a dicyclopentadiene supplied by Lyondell Petrochemical), 169 parts LRO-90® (a hydrocarbon mixture containing vinyl aromatic compounds supplied by Lyondell Petrochemical), 52 parts of SAABA (a polymer comprised of 83.5 wt. % styrene, 6.5 wt % acrylic acid, and 10 wt. % butyl acrylate and having an acid number of 47), and 52 parts maleic anhydride. The charged autoclave was purged with nitrogen and sealed. The reaction mixture was heated to 265° C. over a 60 minute period and was maintained at 260° C. for four hours. The reactor was then vented carefully, and the molten resin was poured into an aluminum pan and was allowed to cool.

Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 260° C. At 260° C., the nitrogen inlet tube was immersed in the liquid resin and the nitrogen flow was adjusted to a rate of approximately 400 ml/min. The resin was sparged for four hours and then discharged into an aluminum pan.

The resulting hydrocarbon/acrylic resin composition had an acid number of 46, a Ring and Ball softening point of 152° C., and a efflux cup dilution (#2 Shell Cup, 25° C., 18 sec end point) of 42 mL.

A 50 wt. % solution of the resin was prepared by dissolving 152 parts of the resin in toluene. This solution was placed in a 500-mL, four-neck, round-bottom flask equipped with an electric heating mantle, overhead stirrer, thermocouple, nitrogen inlet tube, and Barret trap attached to a water-cooled condenser. To this solution was added 3 parts lime. The contents were heated to 270° C. and water was removed. The resulting resinate had a viscosity of 23 line-to-line seconds, a capillary melt point of 182° C., and a toluene dilution of 130 mL (#2 Shell Cup, 25° C., 18 sec end point).

### EXAMPLE 9

Into a one-liter autoclave reactor were charged 455 parts of DCPD 101® (a dicyclopentadiene supplied by Lyondell Petrochemical), 143 parts LRO-90® (a hydrocarbon mixture containing vinyl aromatic compounds supplied by Lyondell Petrochemical), 26 parts of SAAEHA (a polymer comprised of 60 wt. % styrene, 20 wt. % acrylic acid, and 20 wt. % 2-ethyl hexyl acrylate and having an acid number of 128), and 26 parts maleic anhydride. The charged autoclave was purged with nitrogen and sealed. The reaction mixture was heated to 265° C. over a 30 minute period and was maintained at 260° C. for seven hours. The reactor was then vented carefully, and the molten resin was poured into an aluminum pan and was allowed to cool.

Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 260° C. At 260° C., the nitrogen inlet tube was immersed in the liquid resin and the nitrogen flow was adjusted to a rate of approximately 400 ml/min. The resin was sparged for four hours and then discharged into an aluminum pan.

The resulting hydrocarbon/acrylic resin composition had an acid number of 23, a Ring and Ball softening point of 162° C., and a efflux cup dilution (#2 Shell Cup, 25° C., 18 sec end point) of 42 mL.

### EXAMPLE 10

Into a one-liter autoclave reactor were charged 455 parts of DCPD 101® (a dicyclopentadiene supplied by Lyondell Petrochemical), 143 parts LRO-90® (a hydrocarbon mixture containing vinyl aromatic compounds supplied by Lyondell Petrochemical), 26 parts IPAFSH28 (a polymer comprised of 35 wt. % α-methyl styrene, 33 wt. % styrene, 27 wt. % acrylic acid, and 5 wt. % NEODENE® 16 (a 1 -hexadecene supplied by Shell Chemical Co.) and having an acid number of 184), and 26 parts maleic anhydride. The charged autoclave was purged with nitrogen and sealed. The reaction mixture was heated to 265° C. over a 30 minute period and was maintained at 260° C. for six hours. The reactor was then vented carefully, and the molten resin was poured into an aluminum pan and was allowed to cool.

Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 260° C. At 260° C., the nitrogen inlet tube was immersed in the liquid resin and the nitrogen flow was adjusted to a rate of approximately 400 ml/min. The resin was sparged for four hours and then discharged into an aluminum pan.

The resulting hydrocarbon/acrylic resin composition had an acid number of 26 and a Ring and Ball softening point of 191° C. The resin was not soluble in alkaline refined linseed oil or MAGIESOL® 47 oil (a hydrocarbon solvent supplied by Magie Brothers Oil Co.).

### EXAMPLE 11

Into a one-liter autoclave reactor were charged 390 parts of DCPD 101® (a dicyclopentadiene supplied by Lyondell Petrochemical), 182 parts LRO-90® (a hydrocarbon mixture containing vinyl aromatic compounds supplied by Lyondell Petrochemical), 26 parts SAAEHA (a solution polymer comprised of 60 wt. % styrene, 20 wt. % acrylic acid, and 20 wt. % 2-ethyl hexyl acrylate and having an acid number of 128), 26 parts maleic anhydride, and 26 parts NEODENE® C-16 (a 1-hexadecene supplied by Shell Chemical Co.). The charged autoclave was purged with nitrogen and sealed. The reaction mixture was heated to 265° C. over a 30 minute period and was maintained at 260° C. for six hours. The reactor was then vented carefully, and the molten resin was poured into an aluminum pan and was allowed to cool.

Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 260° C. At 260° C., the nitrogen inlet tube was immersed in the liquid resin and the nitrogen flow was adjusted to a rate of approximately 400 ml/min. The resin was sparged for four hours and then discharged into an aluminum pan.

The resulting hydrocarbon/acrylic resin composition had an acid number of 24, a Ring and Ball softening point of 90° C., a viscosity at 25° C. of 5 line-to-line seconds (33 wt. % resin in alkaline refined linseed oil), a Gardner color of 11+ (33 wt. % resin in alkaline refined linseed oil), and a efflux cup dilution (#2 Shell Cup, 25° C., 18 sec end point) of 22 mL.

### EXAMPLE 12

Into a one-liter autoclave reactor were charged 390 parts of DCPD 101® (a dicyclopentadiene supplied by Lyondell Petrochemical), 182 parts LRO-90® (a hydrocarbon mixture containing vinyl aromatic compounds supplied by Lyondell Petrochemical), 26 parts SAAEHA (a polymer comprised of 60 wt. % styrene, 20 wt. % acrylic acid, and 20 wt. % 2-ethyl hexyl acrylate and having an acid number of 128), 13 parts maleic anhydride, and 26 parts NEODENEV C-16 (1-hexadecene supplied by Shell Chemical Co.). The charged autoclave was purged with nitrogen and sealed. The reaction mixture was heated to 265° C. over a 30 minute period and was maintained at 260° C. for six hours. The reactor was then vented carefully, and the molten resin was poured into an aluminum pan and was allowed to cool.

Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 260° C. At 260° C., the nitrogen inlet tube was immersed in the liquid resin and the nitrogen flow was adjusted to a rate of approximately 400 ml/min. The resin was sparged for one hour and then discharged into an aluminum pan.

The resulting hydrocarbon/acrylic resin composition had an acid number of 14, a Ring and Ball softening point of 137° C., a viscosity at 25° C. of 8 line-to-line seconds (33 wt. % resin in Alkaline refined linseed oil) and 16 line-to-line seconds (50 wt. % resin in MAGIESOL® 47 oil [a hydrocarbon solvent supplied by Magie Brothers Oil Co.]), and 44% tolerance (titration of the resin/MAGIESOL® 47 oil solution with additional oil until a cloud point is reached).

### EXAMPLE 13

Into a one-liter autoclave reactor were charged 390 parts of DCPD 101® (a dicyclopentadiene supplied by Lyondell Petrochemical), 182 parts LRO-90® (a hydrocarbon mixture containing vinyl aromatic compounds supplied by Lyondell Petrochemical), 26 parts 7098-26 (a polymer comprised of 83.5 wt. % styrene, 6.5 wt. % acrylic acid, and 10.0 wt. % isodecyl methacrylate and having an acid number of 44), 13 parts maleic anhydride, and 26 parts NEODENE® C-16 (1-hexadecene supplied by Shell Chemical Co.). The charged autoclave was purged with nitrogen and sealed. The reaction mixture was heated to 265° C. over a one hour period and was maintained at 260° C. for 6.5 hours. The reactor was then vented carefully, and the molten resin was poured into an aluminum pan and was allowed to cool.

Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 260° C. At 260° C., the nitrogen inlet tube was immersed in the liquid resin and the nitrogen flow was adjusted to a rate of approximately 400 ml/min. The resin was sparged for four hours and then discharged into an aluminum pan.

The resulting hydrocarbon/acrylic resin composition had an acid number of 14, a Ring and Ball softening point of 141° C., a viscosity at 25° C. of 8 line-to-line seconds (33 wt. % resin in alkaline refined linseed oil), a Gardner color of 12+ (33 wt. % resin in alkaline refined linseed oil), and a efflux cup dilution (#2 Shell Cup, 25° C., 18 sec end point) of 28 mL.

### EXAMPLE 14

Into a one-liter, round-bottom, five-neck flask equipped with a electric heating mantle, overhead stirrer, thermocouple, nitrogen inlet tube, and Barret trap attached to a water-cooled condenser was charged 225 parts of the resin of Example 8. The resin was heated to a temperature of 200° C. under a nitrogen blanket and then 11.3 parts diethylene glycol was added. The temperature was increased to 230° C. and was maintained for a period of six hours. The resin was sparged for 30 minutes and then discharged into an aluminum pan.

The resulting hydrocarbon/acrylic resin composition had an acid number of 26, a Ring and Ball softening point of 170° C., and a efflux cup dilution (#2 Shell Cup, 25° C., 18 sec end point) of 84 mL.

### EXAMPLE 15

Into a 500-mL, round-bottom, four-neck flask equipped with a electric heating mantle, overhead stirrer, thermocouple, nitrogen inlet tube, and Barret trap attached to a water-cooled condenser was charged 200 parts of the resin of Example 5 and 20 parts maleic anhydride. The temperature was increased to 200° C. and was maintained for three hours. Then, 10 parts SP 134 (an alkylphenol-formaldehyde thermosetting resin supplied by Schenectady International Inc.) was added. After a period of one hour, the resin was discharged into an aluminum pan.

The resulting hydrocarbon/acrylic resin composition had an acid number of 49, a Ring and Ball softening point of 175° C., and a efflux cup dilution (#2 Shell Cup, 25° C., 18 sec end point) of 132 mL.

### EXAMPLE 16

Into a 500-mL, round-bottom, four-neck flask equipped with a electric heating mantle, overhead stirrer, thermocouple, nitrogen inlet tube, and Barret trap attached to a water-cooled condenser was charged 150 parts of the resin of Example 4 and 5 parts maleic anhydride. The resin was heated to a temperature of 180° C. under a nitrogen blanket and then 20 parts ROSIN SS® (a tall oil rosin supplied by the Westvaco Corp.) was added. The temperature was increased to 275° C. and was maintained for a period of three hours. The temperature was decreased to 210° C. and then 5.5 grams of pentaerythritol was added. The temperature was increased to 275° C. and was maintained for 90 minutes. The resin was then discharged into an aluminum pan.

The resulting hydrocarbon/acrylic resin composition had an acid number of 64, a Ring and Ball softening point of 150° C., and a efflux cup dilution (#2 Shell Cup, 25° C., 18 sec end point) of 86 mL.

### EXAMPLE 17

Into a one-liter autoclave reactor were charged 1401 parts of DCPD 101® (a dicyclopentadiene supplied by Lyondell Petrochemical), 602 parts LRO-90® (a hydrocarbon mixture containing vinyl aromatic compounds supplied by Lyondell Petrochemical), 120 parts of NEODENE® 16 (a 1-hexadecene supplied by Shell Chemical Co.), and 100 parts JONREZ® H-2701 (a styrene/acrylic polymer having an acid number of 206 supplied by the Westvaco Corp.). The charged autoclave was purged with nitrogen and sealed. The reaction mixture was heated to 260° C. over a 90 minute period and was maintained at 260° C. for five hours. The reactor was then vented carefully, and the molten resin was poured into an aluminum pan and was allowed to cool.

Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 220° C. At 220° C., the nitrogen inlet tube was immersed in the liquid resin and the nitrogen flow was adjusted to a rate of approximately 400 ml/min. The resin was sparged for two hours and then discharged into an aluminum pan.

The resulting hydrocarbon/acrylic resin composition had an acid number of 4, a glass transition temperature of 2° C., a weight average molecular weight of 5960 daltons, a Brookfield viscosity at 135° C. of 4780 cP, and a Ring and Ball softening point of 79° C.

### EXAMPLE 18

Into a one-liter autoclave reactor were charged 1708 parts of DCPD 101® (a dicyclopentadiene supplied by Lyondell Petrochemical), 752 parts LRO-90® (a hydrocarbon mixture containing vinyl aromatic compounds supplied by Lyondell Petrochemical), and 150 parts NEODENE® 16 (a 1-hexadecene supplied by Shell Chemical Co.). The charged autoclave was purged with nitrogen and sealed. The reaction mixture was heated to 260° C. over a two hour period and was maintained at 260° C. for five hours. The reactor was then vented carefully, and the molten resin was poured into an aluminum pan and was allowed to cool.

Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 220° C. At 220° C., the nitrogen inlet tube was immersed in the liquid resin and the nitrogen flow was adjusted to a rate of approximately 400 ml/min. The resin was sparged for two hours and then discharged into an aluminum pan.

The resulting hydrocarbon/acrylic resin composition had a glass transition temperature of 3° C., a weight average molecular weight of 1290 daltons, a Brookfield viscosity at 135° C. of 455 cP, and a Ring and Ball softening point of 54° C.

### EXAMPLE 19

To a one-liter, four-neck, round-bottom flask equipped with an electric heating mantle, overhead stirrer, thermocouple, nitrogen inlet tube, and Barret trap attached to a water-cooled condenser were added 400 parts of the resin prepared in Example 18 and 126 parts JONREZ® H-2701 (a styrene/acrylic acid polymer having an acid number of 206 supplied by the Westvaco Corp.). The contents of the flask were heated to a temperature of 220° C. After five hours at 220° C., the resulting hydrocarbon/acrylic resin composition was collected in an aluminum pan. The resin had an acid number of 32, a weight average molecular weight of 8700 daltons, and a softening point of 146° C.

### EXAMPLE 20

To a one-liter, four-neck, round-bottom flask equipped with an electric heating mantle, overhead stirrer, thermocouple, nitrogen inlet tube, and Barret trap attached to a water-cooled condenser were added 1000 parts of the resin prepared in Example 18 and 190 parts JONREZ® H-2703 (a styrene/acrylic acid polymer having an acid number of 206 supplied by the Westvaco Corp.). The contents of the flask were heated to a temperature of 260° C. After five hours at 260° C., the resulting hydrocarbon/acrylic resin composition was collected in an aluminum pan. The resin had a weight average molecular weight of 2170 daltons, a glass transition temperature of 31° C., and a softening point of 101° C.

### EXAMPLE 21

To a one-liter, four-neck, round-bottom flask equipped with an electric heating mantle, overhead stirrer, thermocouple, nitrogen inlet tube, and Barret trap attached to a water-cooled condenser were added 350 parts of the resin described in Example 17 and 40 parts maleic anhydride. The contents of the flask were heated to a temperature of 190° C. After five hours at 190° C., the resulting hydrocarbon/acrylic resin composition was collected in an aluminum pan. The resin had an acid number of 60, a weight average molecular weight of 7970 daltons, and a softening point of 121° C.

### EXAMPLE 22

To a one-liter, four-neck, round-bottom flask equipped with an electric heating mantle, overhead stirrer, thermocouple, nitrogen inlet tube, and Barret trap attached to a water-cooled condenser were added 350 parts of the resin described in Example 17 and 40 parts maleic anhydride. The contents of the flask were heated to a temperature of 190° C. After four hours at 190° C., five parts of diethylene glycol was added and the temperature was increased to 260° C. After two hours at 260° C., the resulting hydrocarbon/acrylic resin composition was collected in an aluminum pan. The resin had an acid number of 53, a weight average molecular weight of 15.5K daltons, and a softening point of 140° C.

### EXAMPLE 23

Into a one-liter autoclave reactor were charged 1399 parts of DCPD 101® (a dicyclopentadiene supplied by Lyondell Petrochemical), 603 parts LRO-90® (a hydrocarbon mixture containing vinyl aromatic compounds supplied by Lyondell Petrochemical), 120 parts of NEODENE® 16 (a 1-hexadecene supplied by Shell Chemical Co.), and 402 parts JONREZ® H-2703 (a styrene/acrylic polymer having a hydroxyl value of 90 supplied by the Westvaco Corp.). The charged autoclave was purged with nitrogen and sealed. The reaction mixture was heated to 260° C. over a 90 minute period and was maintained at 260° C. for five hours. The reactor was then vented carefully, and the molten resin was poured into an aluminum pan and was allowed to cool.

Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 220° C. At 220° C., the nitrogen inlet tube was immersed in the liquid resin and the nitrogen flow was adjusted to a rate of approximately 400 ml/min. The resin was sparged for two hours and then discharged into an aluminum pan.

The resulting hydrocarbon/acrylic resin composition had a weight average molecular weight of 1760 daltons and a Ring and Ball softening point of 81° C.

### EXAMPLE 24

To a one-liter, four-neck, round-bottom flask equipped with an electric heating mantle, overhead stirrer, thermocouple, nitrogen inlet tube, and Barret trap attached to a water-cooled condenser were added 210 parts of the resin prepared in Example 18 and 9.5 parts JONREZ® H-2701 (a styrene/acrylic acid polymer having an acid number of 210 supplied by the Westvaco Corp.). The contents of the flask were heated to a temperature of 260° C. After five hours at 260° C., the resulting hydrocarbon/acrylic resin composition was collected in an aluminum pan. The resin had a weight average molecular weight of 2400 daltons and a glass transition temperature of 116° C.

### EXAMPLE 25

To a one-liter, four-neck, round-bottom flask equipped with an electric heating mantle, overhead stirrer, thermocouple, nitrogen inlet tube, and Barret trap attached to a water-cooled condenser were added 1000 parts of the resin prepared in Example 18 and 190 parts JONREZ® H-2703 (a styrene/acrylic acid polymer having a hydroxyl number of 90 supplied by the Westvaco Corp.). The contents of the flask were heated to a temperature of 260° C. After five hours at 260° C., the resulting hydrocarbon/acrylic resin composition was collected in an aluminum pan. The resin had a weight average molecular weight of 2169 daltons, a glass transition temperature of 31° C., and a softening point of 101° C.

### EXAMPLE 26

Into a one-liter autoclave reactor were charged 1066 parts of DCPD 101® (a dicyclopentadiene supplied by Lyondell Petrochemical), 451 parts LRO-90® (a hydrocarbon mixture containing vinyl aromatic compounds supplied by Lyondell Petrochemical), 350 parts JONREZ® H-2704 (a styrene/acrylic polymer having an acid number of 44 supplied by the Westvaco Corp.), and 50 parts NEODENE® C-16 (a 1-hexadecene supplied by Shell Chemical Co.). The charged autoclave was purged with nitrogen and sealed. The reaction mixture was heated to 265° C. over a one hour period and was maintained at 260° C. for five hours. The reactor was then vented carefully, and the molten resin was poured into an aluminum pan and was allowed to cool.

Next, the resin was added to a one-liter, four-neck, round-bottom flask equipped with an electric heating mantle, overhead stirrer, thermocouple, nitrogen inlet tube, and Barret trap attached to a water-cooled condenser. The vessel was purged with nitrogen as the resin was heated to 260° C. At 260° C., the nitrogen inlet tube was immersed in the liquid resin and the nitrogen flow was adjusted to a rate of approximately 400 ml/min. The resin was sparged for four hours and then discharged into an aluminum pan.

The resulting hydrocarbon/acrylic resin composition had an acid number of 3, a Ring and Ball softening point of 131° C., a glass transition temperature of 75° C., and a weight average molecular weight of 6550 daltons.

While the invention has been described and illustrated herein by references to various specific materials, procedures, and examples, it is understood that the invention is not restricted to the particular materials, combination of materials, and procedures selected for that purpose. Many modifications and variations of the present invention will be apparent to one of ordinary skill in the art in light of the above teachings. It is therefore understood that the scope of the invention is not to be limited by the foregoing description, but rather is to be defined by the claims appended hereto.

What is claimed is:

1. A method for producing a hydrocarbon/acrylic hybrid resin composition comprising reacting:
a) about 2% to about 63% by total weight of the reactants of dicyclopentadiene;
b) about 2% to about 63% by total weight of the reactants of a member selected from the group consisting of hydrocarbon monomers capable of undergoing polymerization with dicyclopentadiene and combinations thereof;
c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b); and
d) up to about 63% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 160° C. to about 300° C. for a time sufficient to produce the hydrocarbon/acrylic hybrid resin composition.

2. The method of claim 1 which further comprises reacting:
a) about 10% to about 40% by total weight of the reactants of dicyclopentadiene;
b) about 10% to about 40% by total weight of the reactants of a member selected from the group consisting of hydrocarbon monomers capable of undergoing polymerization with dicyclopentadiene and combinations thereof;
c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b); and
d) up to about 40% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 220° C. to about 280° C. for a time sufficient to produce the hydrocarbon/acrylic hybrid resin composition.

3. The method of claim 1 wherein said alcohol is a member selected from the group consisting of alcohols capable of undergoing an insertion reaction across a norbornyl site, alcohols capable of undergoing an esterification reaction with an acid group, alcohols capable of undergoing an esterification reaction with an acid equivalent functional group, and combinations thereof.

4. The method of claim 1 wherein said alkyl amine is a member selected from the group consisting of alkyl amines capable of undergoing an insertion reaction across a norbornyl site, alkyl amines capable of undergoing an esterification reaction with an acid group, alkyl amines capable of undergoing an esterification reaction with an acid equivalent functional group, and combinations thereof.

5. The method of claim 1 wherein said α,β-unsaturated carboxylic acid is a member selected from the group consisting of α,β-unsaturated carboxylic acids capable of undergoing an insertion reaction across a norbornyl site, α,β-unsaturated carboxylic acids capable of undergoing an esterification reaction with an acid group, α,β-unsaturated carboxylic acids capable of undergoing an esterification reaction with an acid equivalent functional group, α,β-unsaturated carboxylic acids capable of undergoing a Diels-Alder addition reaction, α,β-unsaturated carboxylic acids capable of undergoing an ene-reaction, and combinations thereof.

6. The method of claim 1 wherein said α,β-unsaturated carboxylic diacid is a member selected from the group consisting of α,β-unsaturated carboxylic diacids capable of undergoing an insertion reaction across a norbornyl site, α,β-unsaturated carboxylic diacids capable of undergoing an esterification reaction with an acid group, α,β-unsaturated diacids capable of undergoing an esterification reaction with an acid equivalent functional group, α,β-unsaturated carboxylic diacids capable of undergoing a Diels-Alder addition reaction, α,β-unsaturated carboxylic diacids capable of undergoing an ene-reaction, and combinations thereof.

7. The method of claim 1 wherein said α,β-unsaturated carboxylic anhydride is a member selected from the group consisting of α,β-unsaturated carboxylic anhydrides capable of undergoing an insertion reaction across a norbornyl site, α,β-unsaturated carboxylic anhydrides capable of undergoing an esterification reaction with an acid group, α,β-unsaturated anhydrides capable of undergoing an esterification reaction with an acid equivalent functional group, α,β-unsaturated carboxylic anhydrides capable of undergoing a Diels-Alder addition reaction, α,β-unsaturated carboxylic anhydrides capable of undergoing an ene-reaction, and combinations thereof.

8. The method of claim 1 wherein said fatty acid is a member selected from the group consisting of fatty acids capable of undergoing an insertion reaction across a norbornyl site, fatty acids capable of undergoing an esterification reaction with an acid group, fatty acids capable of undergoing an esterification reaction with an acid equivalent functional group, fatty acids capable of undergoing a Diels-Alder addition reaction, fatty acids capable of undergoing an ene-reaction, and combinations thereof.

9. The method of claim 1 wherein said fatty acid compound is a member selected from the group consisting of fatty acid compounds capable of undergoing an insertion reaction across a norbornyl site, fatty acid compounds capable of undergoing an esterification reaction with an acid group, fatty acid compounds capable of undergoing an esterification reaction with an acid equivalent functional group, fatty acid compounds capable of undergoing a Diels-Alder addition reaction, fatty acid compounds capable of undergoing an ene-reaction, and combinations thereof.

10. The method of claim 1 wherein said rosin acid is a member selected from the group consisting of tall oil rosin, gum rosin, wood rosin, and combinations thereof.

11. The method of claim 1 wherein said mononuclear phenol is a member selected from the group consisting of mononuclear phenols capable of undergoing an insertion reaction across a norbornyl site, mononuclear phenols capable of undergoing an esterification reaction with an acid group, mononuclear phenols capable of undergoing an esterification reaction with an acid equivalent functional group, and combinations thereof.

12. The method of claim 1 wherein said polynuclear phenol is a member selected from the group consisting of polynuclear phenols capable of undergoing an insertion reaction across a norbornyl site, polynuclear phenols capable of undergoing an esterification reaction with an acid group, polynuclear phenols capable of undergoing an esterification reaction with an acid equivalent functional group, and combinations thereof.

13. The method of claim 1 wherein said resole is a member selected from the group consisting of resoles capable of undergoing an insertion reaction across a norbornyl site, resoles capable of undergoing an esterification reaction with an acid group, resoles capable of undergoing an esterification reaction with an acid equivalent functional group, and combinations thereof.

14. The method of claim 1 wherein said novolac is a member selected from the group consisting of novolacs capable of undergoing an insertion reaction across a norbornyl site, novolacs capable of undergoing an esterification reaction with an acid group, novolacs capable of undergoing an esterification reaction with an acid equivalent functional group, and combinations thereof.

15. The method of claim 1 wherein said aldehyde is a member selected from the group consisting of paraformaldehyde, formaldehyde, and combinations thereof.

16. The hydrocarbon/acrylic hybrid resin composition produced by the method of claim 1.

17. An adhesive composition comprising the hydrocarbon/acrylic hybrid resin composition of claim 16.

18. A method for producing a hydrocarbon/acrylic hybrid resin composition comprising:
1) reacting
a) about 2% to about 63% by total weight of the reactants of dicyclopentadiene;
b) about 2% to about 63% by total weight of the reactants of a member selected from the group consisting of hydrocarbon monomers capable of undergoing polymerization with dicyclopentadiene and combinations thereof; and
c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b);
at a temperature of from about 160° C. to about 300° C. for a time sufficient to produce a resin composition; and
2) further reacting:
a) about 35% to about 98% by total weight of the reactants of said resin composition, and
b) about 2% to about 65% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 160° C. to about 300° C. for a time sufficient to produce the hydrocarbon/acrylic hybrid resin composition.

19. The method of claim 18 which further comprises:
1) reacting
a) about 10% to about 40% by total weight of the reactants of dicyclopentadiene;
b) about 10% to about 40% by total weight of the reactants of a member selected from the group consisting of hydrocarbon monomers capable of undergoing polymerization with dicyclopentadiene and combinations thereof; and
c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b);
at a temperature of from about 220° C. to about 280° C. for a time sufficient to produce a resin composition, and
2) further reacting
b) about 50% to about 80% by total weight of the reactants of said resin composition, and
b) about 20% to about 50% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 220° C. to about 280° C. for a time sufficient to produce the hydrocarbon/acrylic hybrid resin composition.

20. The method of claim 18 wherein said alcohol is a member selected from the group consisting of alcohols capable of undergoing an insertion reaction across a norbornyl site, alcohols capable of undergoing an esterification reaction with an acid group, alcohols capable of undergoing an esterification reaction with an acid equivalent functional group, and combinations thereof.

21. The method of claim 18 wherein said alkyl amine is a member selected from the group consisting of alkyl amines capable of undergoing an insertion reaction across a norbornyl site, alkyl amines capable of undergoing an esterification reaction with an acid group, alkyl amines capable of undergoing an esterification reaction with an acid equivalent functional group, and combinations thereof.

22. The method of claim 18 wherein said α,β-unsaturated carboxylic acid is a member selected from the group consisting of α,β-unsaturated carboxylic acids capable of undergoing an insertion reaction across a norbornyl site, α,β-unsaturated carboxylic acids capable of undergoing an esterification reaction with an acid group, α,β-unsaturated carboxylic acids capable of undergoing an esterification reaction with an acid equivalent functional group, α,β-unsaturated carboxylic acids capable of undergoing a Diels-Alder addition reaction, α,β-unsaturated carboxylic acids capable of undergoing an ene-reaction, and combinations thereof.

23. The method of claim 18 wherein said α,β-unsaturated carboxylic diacid is a member selected from the group consisting of α,β-unsaturated carboxylic diacids capable of undergoing an insertion reaction across a norbornyl site, α,β-unsaturated carboxylic diacids capable of undergoing an esterification reaction with an acid group, α,β-unsaturated diacids capable of undergoing an esterification reaction with an acid equivalent functional group, α,β-unsaturated carboxylic diacids capable of undergoing a Diels-Alder addition reaction, α,β-unsaturated carboxylic diacids capable of undergoing an ene-reaction, and combinations thereof.

24. The method of claim 18 wherein said α,β-unsaturated carboxylic anhydride is a member selected from the group consisting of α,β-unsaturated carboxylic anhydrides capable of undergoing an insertion reaction across a norbornyl site, α,β-unsaturated carboxylic anhydrides capable of undergoing an esterification reaction with an acid group, α,β-unsaturated anhydrides capable of undergoing an esterification reaction with an acid equivalent functional group, α,β-unsaturated carboxylic anhydrides capable of undergoing a Diels-Alder addition reaction, α,β-unsaturated carboxylic anhydrides capable of undergoing an ene-reaction, and combinations thereof.

25. The method of claim 18 wherein said fatty acid is a member selected from the group consisting of fatty acids capable of undergoing an insertion reaction across a norbornyl site, fatty acids capable of undergoing an esterification reaction with an acid group, fatty acids capable of undergoing an esterification reaction with an acid equivalent functional group, fatty acids capable of undergoing a Diels-Alder addition reaction, fatty acids capable of undergoing an ene-reaction, and combinations thereof.

26. The method of claim 18 wherein said fatty acid compound is a member selected from the group consisting of fatty acid compounds capable of undergoing an insertion reaction across a norbornyl site, fatty acid compounds capable of undergoing an esterification reaction with an acid group, fatty acid compounds capable of undergoing an esterification reaction with an acid equivalent functional group, fatty acid compounds capable of undergoing a Diels-Alder addition reaction, fatty acid compounds capable of undergoing an ene-reaction, and combinations thereof.

27. The method of claim 18 wherein said rosin acid is a member selected from the group consisting of tall oil rosin, gum rosin, wood rosin, and combinations thereof.

28. The method of claim 18 wherein said mononuclear phenol is a member selected from the group consisting of mononuclear phenols capable of undergoing an insertion reaction across a norbornyl site, mononuclear phenols capable of undergoing an esterification reaction with an acid group, mononuclear phenols capable of undergoing an esterification reaction with an acid equivalent functional group, and combinations thereof.

29. The method of claim 18 wherein said polynuclear phenol is a member selected from the group consisting of polynuclear phenols capable of undergoing an insertion reaction across a norbornyl site, polynuclear phenols capable of undergoing an esterification reaction with an acid group, polynuclear phenols capable of undergoing an esterification reaction with an acid equivalent functional group, and combinations thereof.

30. The method of claim 18 wherein said resole is a member selected from the group consisting of resoles capable of undergoing an insertion reaction across a norbornyl site, resoles capable of undergoing an esterification reaction with an acid group, resoles capable of undergoing an esterification reaction with an acid equivalent functional group, and combinations thereof.

31. The method of claim 18 wherein said novolac is a member selected from the group consisting of novolacs capable of undergoing an insertion reaction across a norbornyl site, novolacs capable of undergoing an esterification reaction with an acid group, novolacs capable of undergoing an esterification reaction with an acid equivalent functional group, and combinations thereof.

32. The method of claim 18 wherein said aldehyde is a member selected from the group consisting of paraformaldehyde, formaldehyde, and combinations thereof.

33. The hydrocarbon/acrylic hybrid resin composition produced by the method of claim 18.

34. An adhesive composition comprising the hydrocarbon/acrylic hybrid resin composition of claim 33.

35. A method for producing a hydrocarbon/acrylic hybrid resin composition comprising reacting:
a) about 2% to about 63% by total weight of the reactants of dicyclopentadiene;
b) about 2% to about 63% by total weight of the reactants of a member selected from the group consisting of hydrocarbon resins, modified hydrocarbon resins, and combinations thereof;
c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b); and
d) up to about 63% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 140° C. to about 300° C. for a time sufficient to produce the hydrocarbon/acrylic hybrid resin composition.

36. The method of claim 35 which further comprises reacting:
a) about 10% to about 40% by total weight of the reactants of dicyclopentadiene;
b) about 10% to about 40% by total weight of the reactants of a member selected from the group consisting of hydrocarbon resins, modified hydrocarbon resins, and combinations thereof;
c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b); and
d) up to about 40% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 180° C. to about 260° C. for a time sufficient to produce the hydrocarbon/acrylic hybrid resin composition.

37. The method of claim 35 wherein said alcohol is a member selected from the group consisting of alcohols capable of undergoing an insertion reaction across a norbornyl site, alcohols capable of undergoing an esterification reaction with an acid group, alcohols capable of undergoing an esterification reaction with an acid equivalent functional group, and combinations thereof.

38. The method of claim 35 wherein said alkyl amine is a member selected from the group consisting of alkyl amines capable of undergoing an insertion reaction across a norbornyl site, alkyl amines capable of undergoing an esterification reaction with an acid group, alkyl amines capable of undergoing an esterification reaction with an acid equivalent functional group, and combinations thereof.

39. The method of claim 35 wherein said α,β-unsaturated carboxylic acid is a member selected from the group consisting of α,β-unsaturated carboxylic acids capable of undergoing an insertion reaction across a norbornyl site, α,β-unsaturated carboxylic acids capable of undergoing an esterification reaction with an acid group, α,β-unsaturated carboxylic acids capable of undergoing an esterification reaction with an acid equivalent functional group, α,β-unsaturated carboxylic acids capable of undergoing a Diels-Alder addition reaction, α,β-unsaturated carboxylic acids capable of undergoing an ene-reaction, and combinations thereof.

40. The method of claim 35 wherein said α,β-unsaturated carboxylic diacid is a member selected from the group consisting of α,β-unsaturated carboxylic diacids capable of undergoing an insertion reaction across a norbornyl site, α,β-unsaturated carboxylic diacids capable of undergoing an esterification reaction with an acid group, α,β-unsaturated diacids capable of undergoing an esterification reaction with an acid equivalent functional group, α,β-unsaturated carboxylic diacids capable of undergoing a Diels-Alder addition reaction, α,β-unsaturated carboxylic diacids capable of undergoing an ene-reaction, and combinations thereof.

41. The method of claim 35 wherein said α,β-unsaturated carboxylic anhydride is a member selected from the group consisting of α,β-unsaturated carboxylic anhydrides capable of undergoing an insertion reaction across a norbornyl site, α,β-unsaturated carboxylic anhydrides capable of undergoing an esterification reaction with an acid group, α,β-unsaturated anhydrides capable of undergoing an esterification reaction with an acid equivalent functional group, α,β-unsaturated carboxylic anhydrides capable of undergoing a Diels-Alder addition reaction, α,β-unsaturated carboxylic anhydrides capable of undergoing an ene-reaction, and combinations thereof.

42. The method of claim 35 wherein said fatty acid is a member selected from the group consisting of fatty acids capable of undergoing an insertion reaction across a norbornyl site, fatty acids capable of undergoing an esterification reaction with an acid group, fatty acids capable of undergoing an esterification reaction with an acid equivalent functional group, fatty acids capable of undergoing a Diels-Alder addition reaction, fatty acids capable of undergoing an ene-reaction, and combinations thereof.

43. The method of claim 35 wherein said fatty acid compound is a member selected from the group consisting of fatty acid compounds capable of undergoing an insertion reaction across a norbornyl site, fatty acid compounds capable of undergoing an esterification reaction with an acid group, fatty acid compounds capable of undergoing an esterification reaction with an acid equivalent functional group, fatty acid compounds capable of undergoing a Diels-Alder addition reaction, fatty acid compounds capable of undergoing an ene-reaction, and combinations thereof.

44. The method of claim 35 wherein said rosin acid is a member selected from the group consisting of tall oil rosin, gum rosin, wood rosin, and combinations thereof.

45. The method of claim 35 wherein said mononuclear phenol is a member selected from the group consisting of mononuclear phenols capable of undergoing an insertion reaction across a norbornyl site, mononuclear phenols capable of undergoing an esterification reaction with an acid group, mononuclear phenols capable of undergoing an esterification reaction with an acid equivalent functional group, and combinations thereof.

46. The method of claim 35 wherein said polynuclear phenol is a member selected from the group consisting of polynuclear phenols capable of undergoing an insertion reaction across a norbornyl site, polynuclear phenols capable of undergoing an esterification reaction with an acid group, polynuclear phenols capable of undergoing an esterification reaction with an acid equivalent functional group, and combinations thereof.

47. The method of claim 35 wherein said resole is a member selected from the group consisting of resoles capable of undergoing an insertion reaction across a norbornyl site, resoles capable of undergoing an esterification reaction with an acid group, resoles capable of undergoing an esterification reaction with an acid equivalent functional group, and combinations thereof.

48. The method of claim 35 wherein said novolac is a member selected from the group consisting of novolacs capable of undergoing an insertion reaction across a norbornyl site, novolacs capable of undergoing an esterification reaction with an acid group, novolacs capable of undergoing an esterification reaction with an acid equivalent functional group, and combinations thereof.

49. The method of claim 35 wherein said aldehyde is a member selected from the group consisting of paraformaldehyde, formaldehyde, and combinations thereof.

50. The hydrocarbon/acrylic hybrid resin composition produced by the method of claim 35.

51. An adhesive composition comprising the hydrocarbon/acrylic hybrid resin composition of claim 50.

52. A method for producing a hydrocarbon/acrylic hybrid resin composition comprising:
1) reacting
a) about 2% to about 63% by total weight of the reactants of dicyclopentadiene;
b) about 2% to about 63% by total weight of the reactants of a member selected from the group consisting of hydrocarbon resins, modified hydrocarbon resins, and combinations thereof; and
c) about 33% to about 96% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b);
at a temperature of from about 140° C. to about 300° C. for a time sufficient to produce a resin composition; and
2) further reacting:
a) about 35% to about 98% by total weight of the reactants of said resin composition, and
b) about 2% to about 65% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 140° C. to about 300° C. for a time sufficient to produce the hydrocarbon/acrylic hybrid resin composition.

53. The method of claim 52 which further comprises:
1) reacting
a) about 10% to about 40% by total weight of the reactants of dicyclopentadiene;
b) about 10% to about 40% by total weight of the reactants of a member selected from the group consisting of hydrocarbon resins, modified hydrocarbon resins, and combinations thereof; and
c) about 40% to about 80% by total weight of the reactants of a member selected from the group consisting of acrylic polymers that are carboxylic acid functionalized, acrylic polymers that are carboxylic acid functionalized and hydroxyl functionalized, and combinations thereof, and wherein said reactants are capable of undergoing cycloaddition reaction with components a) and b);
at a temperature of from about 180° C. to about 260° C. for a time sufficient to produce a resin composition, and
2) further reacting
a) about 50% to about 80% by total weight of the reactants of said resin composition, and
b) about 20% to about 50% by total weight of the reactants of a member selected from the group consisting of alcohols having at least one hydroxyl group, alkyl amines having at least one amine group, metal salts of carboxylic acids, α,β-unsaturated carboxylic acids, α,β-unsaturated carboxylic diacids, α,β-unsaturated carboxylic anhydrides, fatty acids, fatty acid compounds, rosin acids, rosin resins, mononuclear phenols, polynuclear phenols, resoles, novolacs, aldehydes, aldehyde acetals, and combinations thereof;
at a temperature of from about 180° C. to about 260° C. for a time sufficient to produce the hydrocarbon/acrylic hybrid resin composition.

54. The method of claim 52 wherein said alcohol is a member selected from the group consisting of alcohols capable of undergoing an insertion reaction across a norbornyl site, alcohols capable of undergoing an esterification reaction with an acid group, alcohols capable of undergoing an esterification reaction with an acid equivalent functional group, and combinations thereof.

55. The method of claim 52 wherein said alkyl amine is a member selected from the group consisting of alkyl amines capable of undergoing an insertion reaction across a norbornyl site, alkyl amines capable of undergoing an esterification reaction with an acid group, alkyl amines capable of undergoing an esterification reaction with an acid equivalent functional group, and combinations thereof.

56. The method of claim 52 wherein said α,β-unsaturated carboxylic acid is a member selected from the group consisting of α,β-unsaturated carboxylic acids capable of undergoing an insertion reaction across a norbornyl site, α,β-unsaturated carboxylic acids capable of undergoing an esterification reaction with an acid group, α,β-unsaturated carboxylic acids capable of undergoing an esterification reaction with an acid equivalent functional group, α,β-unsaturated carboxylic acids capable of undergoing a Diels-Alder addition reaction, α,β-unsaturated carboxylic acids capable of undergoing an ene-reaction, and combinations thereof.

57. The method of claim 52 wherein said α,β-unsaturated carboxylic diacid is a member selected from the group consisting of α,β-unsaturated carboxylic diacids capable of undergoing an insertion reaction across a norbornyl site, α,β-unsaturated carboxylic diacids capable of undergoing an esterification reaction with an acid group, α,β-unsaturated diacids capable of undergoing an esterification reaction with an acid equivalent functional group, α,β-unsaturated carboxylic diacids capable of undergoing a Diels-Alder addition reaction, α,β-unsaturated carboxylic diacids capable of undergoing an ene-reaction, and combinations thereof.

58. The method of claim 52 wherein said α,β-unsaturated carboxylic anhydride is a member selected from the group consisting of α,β-unsaturated carboxylic anhydrides capable of undergoing an insertion reaction across a norbornyl site, α,β-unsaturated carboxylic anhydrides capable of undergoing an esterification reaction with an acid group, α,β-unsaturated anhydrides capable of undergoing an esterification reaction with an acid equivalent functional group, α,β-unsaturated carboxylic anhydrides capable of undergoing a Diels-Alder addition reaction, α,β-unsaturated carboxylic anhydrides capable of undergoing an ene-reaction, and combinations thereof.

59. The method of claim 52 wherein said fatty acid is a member selected from the group consisting of fatty acids capable of undergoing an insertion reaction across a norbornyl site, fatty acids capable of undergoing an esterification reaction with an acid group, fatty acids capable of undergoing an esterification reaction with an acid equivalent functional group, fatty acids capable of undergoing a Diels-Alder addition reaction, fatty acids capable of undergoing an ene-reaction, and combinations thereof.

60. The method of claim 52 wherein said fatty acid compound is a member selected from the group consisting of fatty acid compounds capable of undergoing an insertion reaction across a norbornyl site, fatty acid compounds capable of undergoing an esterification reaction with an acid group, fatty acid compounds capable of undergoing an esterification reaction with an acid equivalent functional group, fatty acid compounds capable of undergoing a Diels-Alder addition reaction, fatty acid compounds capable of undergoing an ene-reaction, and combinations thereof.

61. The method of claim 52 wherein said rosin acid is a member selected from the group consisting of tall oil rosin, gum rosin, wood rosin, and combinations thereof.

62. The method of claim 52 wherein said mononuclear phenol is a member selected from the group consisting of mononuclear phenols capable of undergoing an insertion reaction across a norbornyl site, mononuclear phenols capable of undergoing an esterification reaction with an acid group, mononuclear phenols capable of undergoing an esterification reaction with an acid equivalent functional group, and combinations thereof.

63. The method of claim 52 wherein said polynuclear phenol is a member selected from the group consisting of polynuclear phenols capable of undergoing an insertion reaction across a norbornyl site, polynuclear phenols capable of undergoing an esterification reaction with an acid group, polynuclear phenols capable of undergoing an esterification reaction with an acid equivalent functional group, and combinations thereof.

64. The method of claim 52 wherein said resole is a member selected from the group consisting of resoles capable of undergoing an insertion reaction across a norbornyl site, resoles capable of undergoing an esterification reaction with an acid group, resoles capable of undergoing an esterification reaction with an acid equivalent functional group, and combinations thereof.

65. The method of claim 52 wherein said novolac is a member selected from the group consisting of novolacs capable of undergoing an insertion reaction across a norbornyl site, novolacs capable of undergoing an esterification reaction with an acid group, novolacs capable of undergoing an esterification reaction with an acid equivalent functional group, and combinations thereof.

66. The method of claim 52 wherein said aldehyde is a member selected from the group consisting of paraformaldehyde, formaldehyde, and combinations thereof.

67. The hydrocarbon/acrylic hybrid resin composition produced by the method of claim 52.

68. An adhesive composition comprising the hydrocarbon/acrylic hybrid resin composition of claim 67.
